(19) United States
(12) Patent Application Publication
(10) Pub. No.: US 2018/0014514 A1
(43) Pub. Date: Jan. 18, 2018

(54) Bee-All Inner Cover Feeder

(71) Applicant: Mark David Freneaux, Baton Rouge, LA (US)

(72) Inventor: Mark David Freneaux, Baton Rouge, LA (US)

(21) Appl. No.: 15/648,547

(22) Filed: Jul. 13, 2017

Related U.S. Application Data
(60) Provisional application No. 62/363,801, filed on Jul. 18, 2016.

(51) Int. Cl. A01K 53/00; A01K 47/06

(52) U.S. Cl. CPC A01K 53/00; A01K 47/06

(57) ABSTRACT

The Bee-All Inner Cover Feeder provides beekeepers with the ability to monitor and feed bee colonies with minimal intrusion into the hive and provides protection of the pollen substitute and sugar water from predator insects and other bees. These features make the Bee-All Inner Cover Feeder unique in the field of beekeeping. The previously unavailable feeder cartridge approach combines the provision of pollen substitute and sugar water to the hive without opening the hive lid, and places the feed deep within the hive, accessible only to that colony of bees. The Bee-All Inner Cover Feeder is a simple but revolutionary delivery system for pollen substitute and sugar water which minimizes intrusion into the hive, protects the feed from other insects, and saves beekeeper time and effort. Taken together, these benefits increase the health and productivity of the bee colonies.

### BACKGROUND OF THE INVENTION

During seasons of the year when nectar and pollen are not available to honey bees in nature, many beekeepers provide sugar water and/or pollen substitute for the bees so that they may continue to breed and strengthen the hive to increase honey production. There are many delivery methods for the sugar water and pollen substitute, some of which are patented and/or sold at retail.

The currently available delivery methods of pollen substitutes and sugar water either require an invasive opening of the hive, or the placement of the pollen substitute and sugar water where it can be accessed by predator insects and bees from other colonies. The Bee-All Inner Cover Feeder is designed to deliver sugar water and pollen substitute to the hive with minimal disturbance to the colony of bees and complete protection from predator insects and bees from other colonies. The Bee-All Inner Cover Feeder allows the same protection and convenience when additional ventilation is created by setting the hive lid on the provided removable pegs.

### BRIEF SUMMARY OF THE INVENTION

The Bee-All Inner Cover Feeder takes the unique approach of combining the provision of sugar water and pollen to the hive in a single assembly which can be inspected or removed and refilled with minimal disturbance to the hive.

The Bee-All Inner Cover Feeder also places the feeding mechanism safely inside the top cover of the hive, and screens out would-be predators or robber bees from accessing the sugar water and pollen.

The Bee-All Inner Cover Feeder also is equipped with removable pegs which, when in place, lift the hive lid and provide ventilation to the hive in hot weather. When ventilation is not desired, the pegs are removed and the hive lid sits flush on the top of the Bee-All Inner Cover Feeder.

### BRIEF DESCRIPTION OF THE SEVERAL VIEWS OF THE DRAWING

FIG. 1—Perspective overview of Part A, Main Housing, with Part C Removable Pegs, inserted.

FIG. 2—Top View of Part A, Main Housing.

FIG. 3—Top View of Part A, Main Housing, with screen indicated in light grey.

FIG. 4—Bottom view of Part A, Main Housing.

FIG. 5—Side view of Part A, Main Housing.

FIG. 6—Rear view of Part A, Main Housing.

FIG. 7—Front view of Part A, Main Housing.

FIG. 8—Side view crossection of Part A, Main Housing (screen indicated by dotted line.)

FIG. 9—Side view of Part A, Main Housing, with Part B, Feeder Cartridge, and Part C, Removable Pegs.

FIG. 10—Side view of Part B, Feeder Cartridge.

FIG. 11—Side view of Part C, Removable Peg

FIG. 12—Front View of Part A, Main Housing, with Part B, Feeder Cartridge, inserted.

FIG. 13—Partial perspective view of Part A, Main Housing, with Part B, Feeder Cartridge, inserted.

### DETAILED DESCRIPTION OF THE INVENTION

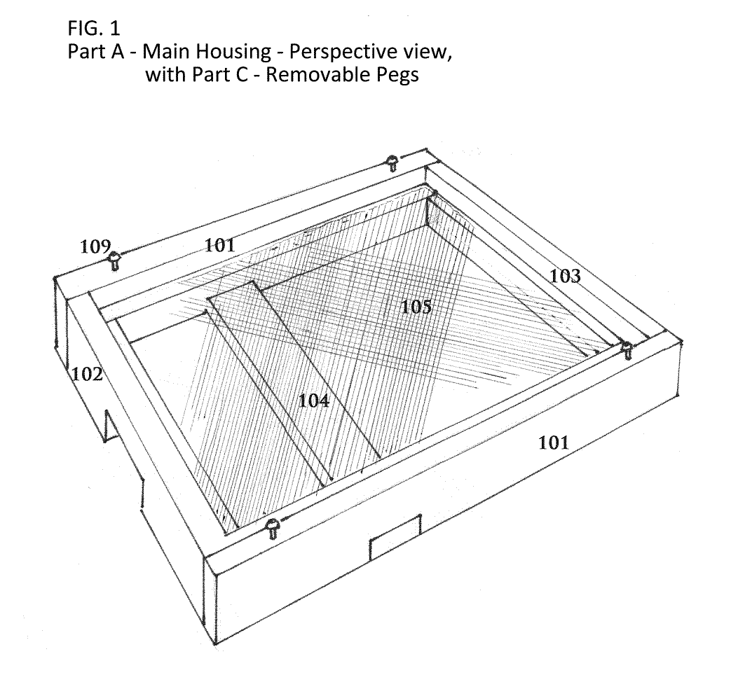

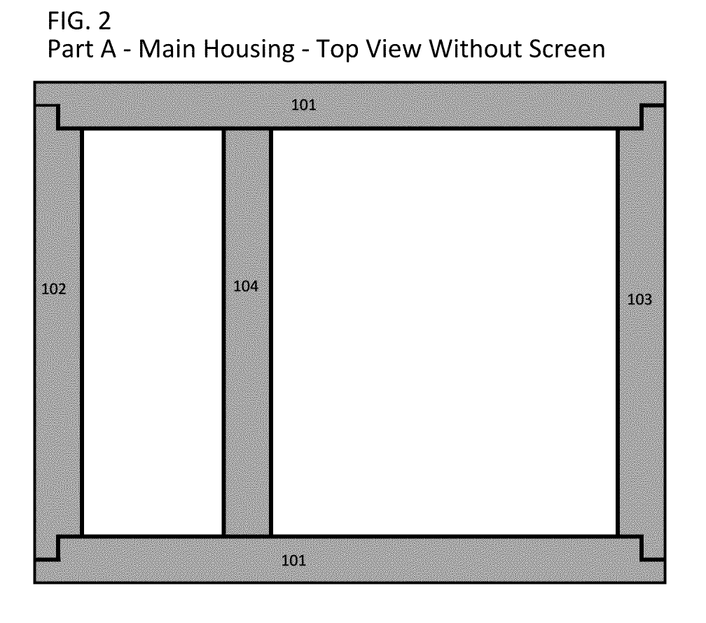

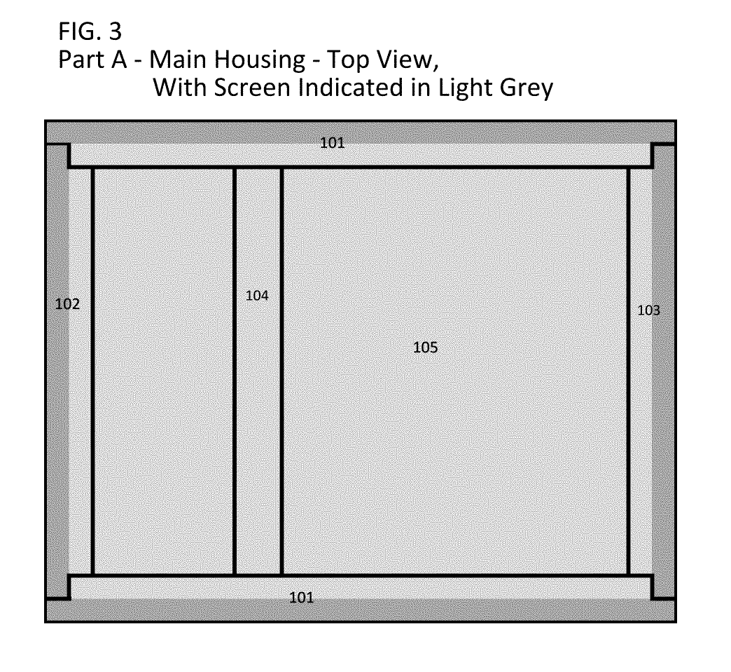

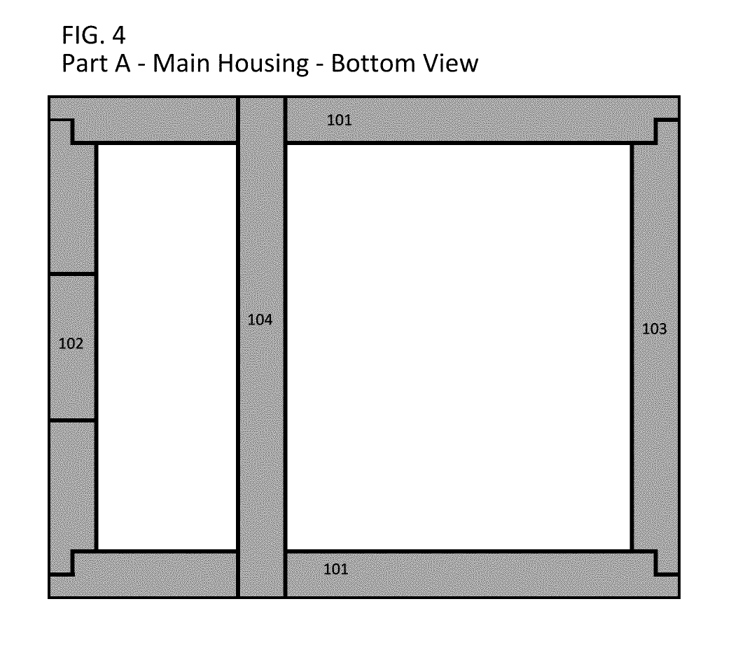

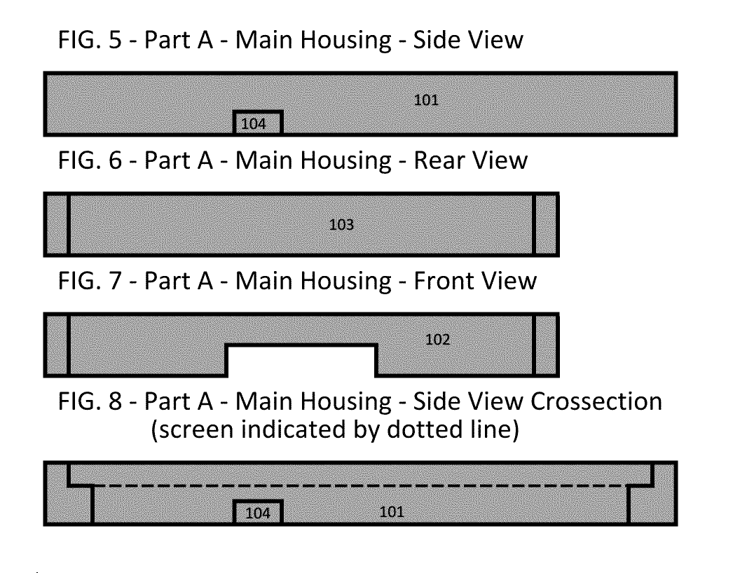

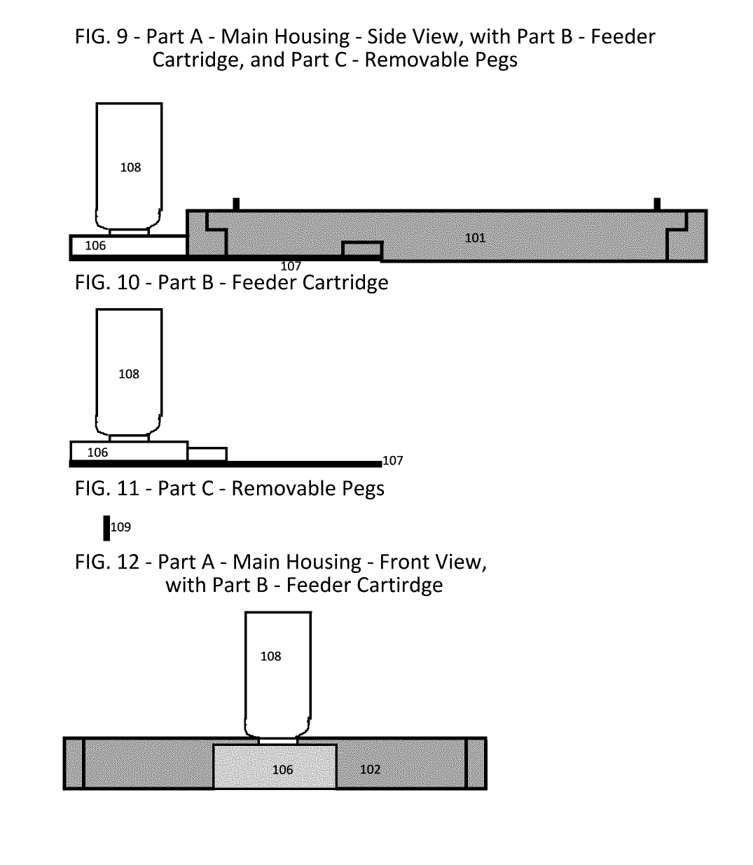

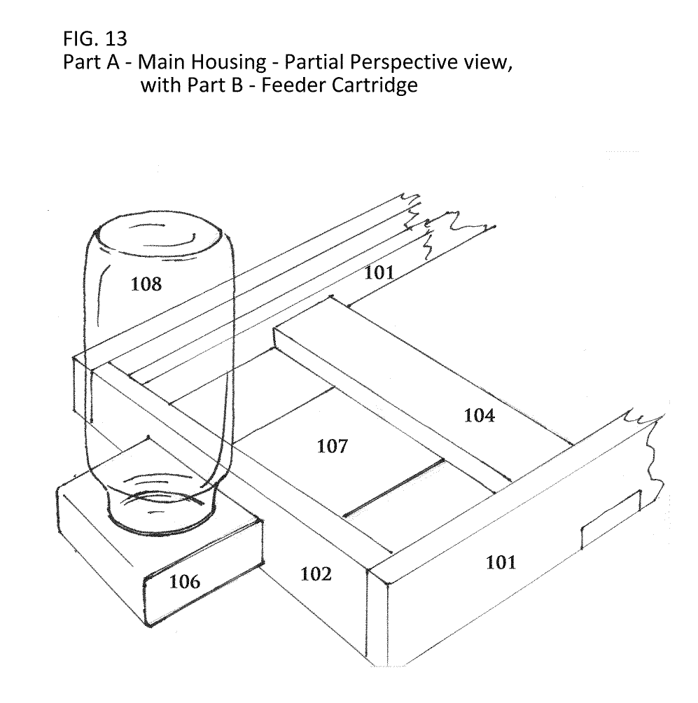

The Bee-All Inner Cover Feeder consists of three components: Part A) the Main Housing (FIGS. 1-9, 12, & 13) consisting of side rails, a cross piece, and a screen, Part B) the Feeder Cartridge (FIGS. 9,10,12, & 13) consisting of a standard entrance feeder attached to a base plate, and Part C) four Removable Pegs (FIGS. 1 & 11) to be inserted into holes in the top of the housing when ventilation is desired.

Side Rails (Ref 101) measure 2″ tall, 1.5″ wide, and 19.875″ long to fit a standard Langstroth hive

Front (Ref 102) and back (Ref 103) rail measure 2″ tall, 1.5: wide, and 14.75″ long to fit a standard Langstroth hive

Overall assembled unit measures 19.875″×16.25″×2″

Cross-piece (Ref 104) measures 1.5″ wide, 0.75″ tall, and 16.25″ long

Side (Ref 101), back (Ref 103) and front (Ref 102) rails and cross piece (Ref 104) may be custom ordered to fit any hive dimension

Screen (Ref 105) is ⅛″ hardware cloth, but can be a finer mesh and made of any flexible or hard material.

Screen (Ref 105) sits in a 0.75″×0.75″ notch cut into the top inside edge of all rails (Ref 101, 102, & 103).

Screen (Ref 105) is stapled down to the outside rails (Ref 101, 102, & 103).

Alternatively, the screen (Ref 105) may be held down by stapling strips of wood over the screen in the groove.

Each side rail (Ref 102) has a 1.5″ wide and 0.75″ tall notch cut to receive the cross-piece (Ref 104).

Material of the unit will generally be wood, but can be manufactured from any solid material.

The five solid pieces (Ref 101, 102, 103 & 104) may be attached by glue, staples, nails, screws, or any combination thereof.

A standard Entrance Feeder is composed of a jar with a perforated lid (Ref 108) which rests in a base (Ref 106) that is open on one end to allow bees to access the sugar water through the perforated lid.

The front rail (Ref 102) is notched 0.875″ tall by 4.5″ wide to receive a standard entrance feeder.

The Bee-All can be manufactured with different feeder openings to accommodate other commonly available entrance feeders.

The entrance feeder base (Ref 106) sits on top of a 4.5″×12″ solid plate (Ref 107), currently metal, but may be plastic, wood, or any other rigid material. Initial designs used 16-gauge galvanized steel or 0.063″ aluminum. The assembly of the entrance feeder base (Ref 106), jar (ref 108), and solid plate (Ref 107) are referred to herein as the Feeder Cartridge (Part B).

The plate (Ref 107) extends to beneath the crosspiece in order to bear the weight of the entrance feeder base (Ref 106) and the jar of sugar water (Ref 108).

The entrance feeder base (Ref 106) is attached to the plate (Ref 107) with screws or glue.

The portion of the plate from the mouth of the feeder base (Ref 106) to the crosspiece (Ref 104) serves as an area to place pollen patties or a pollen substitute.

There are eight 9/32 holes, four on the top and four on the bottom of the unit, 2″ from the end of each side rail, drilled ½″ deep to accept removable metal or wooden pegs (Ref 109) for the hive lid to sit on for ventilation. The unit can be used with either the top or bottom facing upward, depending on the current need of the hive, therefore holes are drilled on both top and bottom.

The Main Housing (Part A), is placed on the top of the hive body and the hive lid is placed on top of the Main Housing (Part A). In order to inspect the hive and determine the amount of pollen substitute remaining, the beekeeper removes the hive lid and the bees remain captive in the hive beneath the screen (Ref 105). If it is determined that additional pollen substitute is needed, the Feeder Cartridge (Part B), is pulled out from the slot in the Main Housing (Part A). The pollen substitute is then added and the Feeder Cartridge (Part B) is slid back into the Main Housing (Part A). If pollen substitute does not need to be added, the jar of sugar water (Ref 108) can be exchanged for a fresh jar without removing the Feeder Cartridge (Part B) from the Main Housing (Part A).

In all cases, a major feature of the Bee-All is the lack of disruption to the hive. The hive lid can be removed and the bees remain undisturbed beneath the screen. This allows for general hive inspection, or to visually determine whether additional pollen substitute is needed in the hive.

The manner in which the Bee-All supports the jar of sugar water is unique in beekeeping. The plate can support the weight without an additional structure or support since it is held in place by the cross-piece. Above the cross-piece and below the screen, there is ample space for bees from the front of the hive to travel unimpeded to and from the feeder.

The Bee-All Inner Cover Feeder provides beekeepers with the ability to monitor and feed bee colonies with minimal intrusion into the hive and provides protection of the pollen substitute and sugar water from predator insects and other bees. These features make the Bee-All Inner Cover Feeder unique in the field of beekeeping.

I claim:

1) The Feeder Cartridge system of the Bee-All Inner Cover Feeder, comprised of the feeder cartridge assembly, screened main housing, and removable pegs, allows beekeepers to inspect and replenish pollen substitutes and sugar water easier and faster than currently available bee-feeding systems with little or no disturbance to the hive.

2) The screened Main Housing of the Bee-All Inner Cover Feeder prevents predator insects and other bees from accessing the pollen substitute and sugar water intended for the hive.

3) The metal plate attached to the entrance feeder, supported by the cross-piece in the main housing, is a unique and unobvious method to support the weight of the sugar water and provide a location accessible without opening the hive to place pollen substitute in the hive.
